(19) United States
(12) Patent Application Publication
(10) Pub. No.: US 2011/0170536 A1
(43) Pub. Date: Jul. 14, 2011

(54) Network path finding apparatus, method, and program

(75) Inventors: Toshio Shinjo, Chiba (JP); Mitsuhiro Kokubun, Chiba (JP)

(73) Assignee: Kousokuya, Inc., Kanagawa (JP)

(21) Appl. No.: 13/064,304

(22) Filed: Mar. 17, 2011

Related U.S. Application Data
(63) Continuation of application No. PCT/JP2009/003901, filed on Aug. 14, 2009.

(30) Foreign Application Priority Data
Sep. 17, 2008 (JP) 2008-238539

(51) Int. Cl. H04L 12/28

(52) U.S. Cl. 370/351

(57) ABSTRACT

To perform a path finding for a network by traversing mutually connected links by means of a link destination table that is a data configuration for representing the network. The link destination table contains, for link IDs of each of the links in the network, a node ID of a node on one side of the link, destination link IDs for the node on one side which are link IDs of other links to that node, a node ID of the node on the other side of the link, destination link IDs of the node on the other side which are link IDs of other links to that node, and interval costs.

### CROSS-REFERENCE TO RELATED APPLICATIONS

This application is a continuation of PCT/JP2009/003901 filed on Aug. 14, 2009, and is based on and claims the benefit of priority of the prior Japanese Patent Application No. 2008-238539, filed on Sep. 17, 2008, the entire contents of which are incorporated herein by reference. The contents of PCT/JP2009/003901 are incorporated herein by reference in their entity.

### BACKGROUND OF THE INVENTION

1. Field of the Invention

This invention is related to a network path finding apparatus, method and program, in particular, a network path finding apparatus, method and program based on a new data configuration for representing networks and is furthermore related to a method for making the new data configuration that represents network.

2. Description of Related Art

Physical networks such as road networks, telecommunications networks, and piping networks are being represented by logical networks on computers and optimal paths are being sought for and transportation costs are being computed. An apparatus for reproducing map information that applies art related to networks is disclosed in Patent Reference 1 below.

As depicted in table 1 and table 2 of patent reference 1, a logical network (hereinbelow simply called a network) of conventional type can be seen to be defined respectively by the nodes and the links connecting those nodes as network elements. Then networks are represented by data related to the attributes of the nodes and the links and, based on that network representation, path finds and other such processes are done.

Referencing FIG. 1A and FIG. 1B, an example of a network configuration and the conventional data configuration that represents that configuration is described. FIG. 1A shows an exemplary configuration for network 1 that consists of nodes 10 (from N1 to N6) and links 12 (from L1 to L8) that model a road network. The node label 10 is only affixed to node N1 and is omitted for the other nodes. Also the link label 12 is only affixed to link L5 and is omitted for the other links. As shown in FIG. 1A, link L1 connects node N1 and node N2, link L2 connects node N2 and node N3, and link L3 connects node N2 and node N4. Link L4 connects node N3 and node N4, and link L5 connects node N3 and node N5. Also, link L6 connects node N4 and node N5, link L7 connects node N4 and node N6, and link L8 connects node N5 and node N6.

FIG. 1B shows an example of the conventional data configuration that represents network 1 shown in FIG. 1A and it has an intersection table 111, a link table 121, and a node table 131.

The intersection table 111 relates nodes, which are the intersections, with links, which are the roads that connect the intersections; and the links linked to a node in node. ID 112 are stored in link ID 114. The example in the drawing shows that link ID L1 is associated with node ID N1 and link IDs L1, L2, and L3 are associated with node ID N2. In the same way, below that, L2, L4, and L5 are stored for N3; L3, L4, L6, and L7 are stored for N4; L5, L6, and L7 are stored for N5; and L7 and L8 are stored for N6. Also, it is clear that what is kept in memory is the parts from the line with N1 to the line with N6. The same applies to the other tables described below.

Link table 121 shows the relationship between a link and the nodes on both sides of the link, and for the links in link ID 122, the node ID of the node on one side 123 and node ID of a node on the other side 124 holds the node IDs of the nodes linked to those links. In the example in the drawing, for link ID L1, node ID N1 and node ID N2 are stored in the column for the node ID on one side 123 and the column for the node ID on the other side 124, and node ID N2 and node ID N3 are stored in the corresponding entries for link ID L2. Below them, in the same way, N2 and N4 are stored for L3, N3 and N4 are stored for L4, N3 and N5 are stored for L5, N4 and N5 are stored for L6, N4 and N6 are stored for L7, and N5 and N6 are stored for L8.

Node table 131 consists of the entries for node ID 132 and node information 133, and it holds node information such as information on the node position and so forth for each node for the nodes with node IDs N1 to N6. Concrete examples of node information are omitted.

Patent Document: JP 1995-146155 A

### SUMMARY OF THE INVENTION

In the conventional representation of networks, both nodes and links are taken as network configurational elements and a plurality of tables are prepared and because it becomes necessary to reference successively this plurality of tables when a path finding is performed, this representation has the disadvantage of having a high processing cost when a path finding is performed.

Thus this invention intends to solve this problem by providing a data configuration that represents networks and presents a small processing load during path finds and by providing a path finding method using that data configuration.

In accordance with this invention, a link destination table is provided as a data configuration representing a network that, for the link ID of each link in the network, contains the node ID of a node on one side of the link (hereinafter, this may be called the A-side node), the A-side destination link IDs, which are the link IDs of other links connected to that A-side node, the node ID of the node on the other side of the link (hereinafter, this may be called the B-side node), and the B-side destination link IDs, which are the link IDs of other links connected to that B-side node.

The link destination table also the cost from the A-side node to the B-side node and the cost from the B-side node to the A-side node, in other words, has linkage costs. Also, in accordance with a preferred embodiment of this invention, the link destination table can contain, for each link, the cost of connecting to the links with the link IDs stored in the destination link IDs for the A-side and B-side nodes. By traversing the links stored in the link destination table and their destination links, paths are sought for from an origin point to a destination point, and the cost of each path is computed, and an optimal path finding is performed.

In other words, when the node on the origin point side is made to be the A-side node, the path finding starts from the link related to the node on the origin point side, and a branch is made to the links in the destination link IDs for the B-side node stored in the line with that link ID in the link destination table and furthermore the branch process of branching to the links in the destination link IDs for the B-side node stored the line with that branched link ID is repeated while computing the costs until the B-side node is the destination point node. Then, of the paths from the origin point to the destination point, the optimal path is made'the find results and is output.

In accordance with the data configuration for representing networks in this invention, the processing cost can be made small because path finds can be done by merely using the link destination table and referencing only link IDs in path branching.

### BRIEF DESCRIPTION OF THE DRAWINGS

FIG. 1A is a drawing describing an example of a network configuration.

FIG. 1B is a drawing describing the data configuration that conventional represented examples of network configurations.

FIG. 2A is a drawing describing an example of function blocks for generating a data configuration that represents a network in one preferred embodiment of this invention.

FIG. 2B is a drawing describing an example of function blocks for a network path finding in one preferred embodiment of this invention.

FIG. 3 is a drawing describing an example of an exemplary hardware configuration in one preferred embodiment of this invention.

FIG. 4A is a drawing describing an example of a data configuration that represents a network in one preferred embodiment of this invention.

FIG. 4B is a drawing describing the concept of generating network representation data from conventional network representation data in one preferred embodiment of this invention.

FIG. 5 is a drawing describing an example of the processing for generating a data configuration that represents a network in one preferred embodiment of this invention.

FIG. 6A is a drawing describing the concept of cost in one preferred embodiment of this invention.

FIG. 6B is a drawing describing an example of a link connection table in one preferred embodiment of this invention.

FIG. 7A is a drawing describing a path expansion for an exemplary network path finding in one preferred embodiment of this invention.

FIG. 7B is a drawing describing an example of a path information table in one preferred embodiment of this invention.

FIG. 8A is a drawing describing an example of an overview of the processing to finding for an optimal path in a network in one preferred embodiment of this invention.

FIG. 8B is a drawing describing an example of the processing flow for a network path finding in one preferred embodiment of this invention.

FIG. 8C is a drawing describing an example of the processing flow to determine an optimal path in one preferred embodiment of this invention.

### DESCRIPTION OF THE PREFERRED EMBODIMENTS

Hereinbelow a best mode for embodying this invention is described referencing drawings.

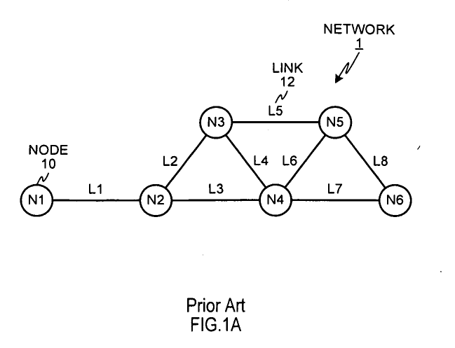

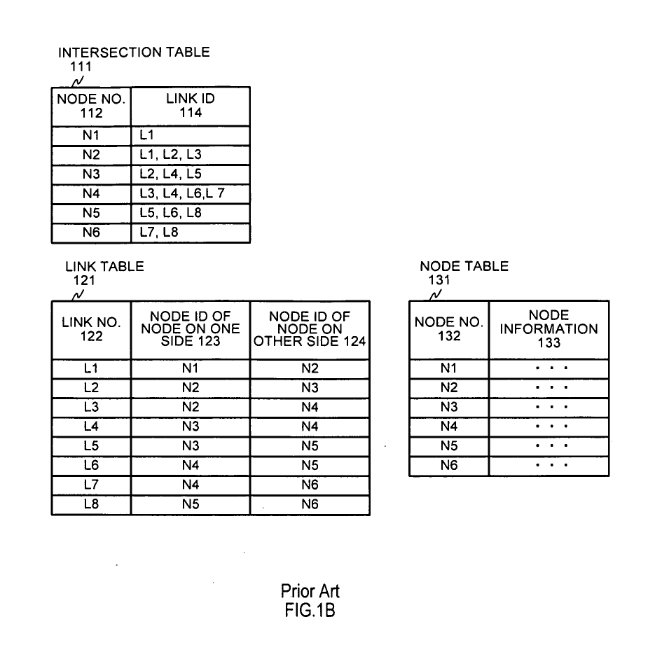

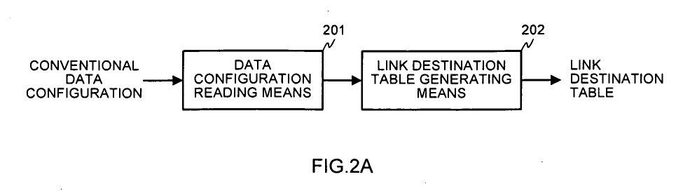

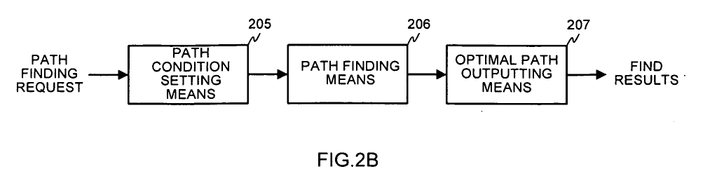

FIG. 2A is a drawing describing an example of function blocks for generating a data configuration that represents a network in one preferred embodiment of this invention. The data configuration reading means 201 reads out data having the conventional data configuration shown in FIG. 1 and, based on that data, the link destination table generating means 202 generates the link destination table.

FIG. 2B is a drawing describing an example of function blocks for a network path finding in one preferred embodiment of this invention. Based on a network path finding request, the path condition setting means 205 sets path conditions such as the link destination table that corresponds to the network for which a path finding has been requested, the origin point node, the destination point node, and so forth. The path finding means 206 finds for paths based on the conditions set by the path condition setting means and computes the cost of those paths at the same time. The optimal path outputting means 207 output as search results, the path with the optimal cost from among the paths found by the path finding means 206.

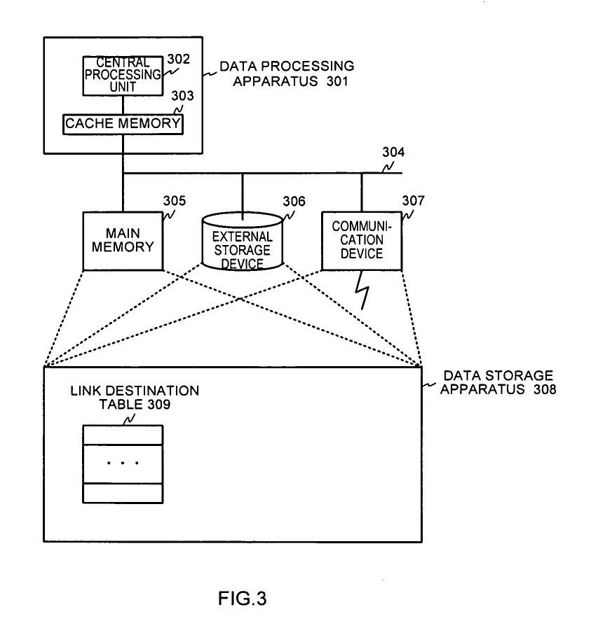

FIG. 3 is a drawing describing an example of an exemplary hardware configuration in one preferred embodiment of this invention.

Path finding processing and the processing to generate a data configuration representing a network are implemented with the network path finding apparatus of the present invention by a data processing apparatus 301 having at least a central processing unit 302 and a cache memory 303, and a data storage apparatus 308. The data storage device 308, which has a link connection table 309, can be implemented by a main memory 305 or an external storage device 306, or alternatively, by using a remotely disposed apparatus connected via communication device 307.

Each function block in the data configuration reading means 201 and so forth described referencing FIG. 2A and FIG. 2B can be implemented by the hardware shown in the example in FIG. 3 and by software that prepares the steps described below.

In the example shown in FIG. 3, although the main memory 305, the storage device 306, and the communication apparatus 307 are coupled to the data processing apparatus 301 by a single bus 304, there is no restriction to this coupling method. The main memory 305 can also be disposed within the data processing apparatus 301.

Also, although it is not particularly illustrated, a temporary memory area can of course be used to enable various values obtained during processing to be used in subsequent processing. In the descriptions below, the values set or stored in a temporary memory area may be called by the name of that temporary memory area.

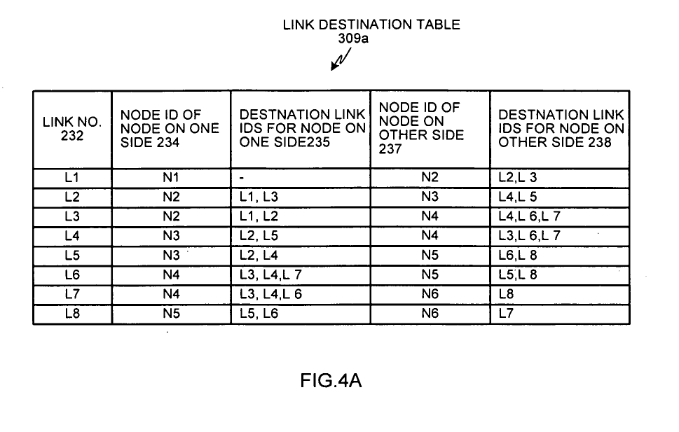

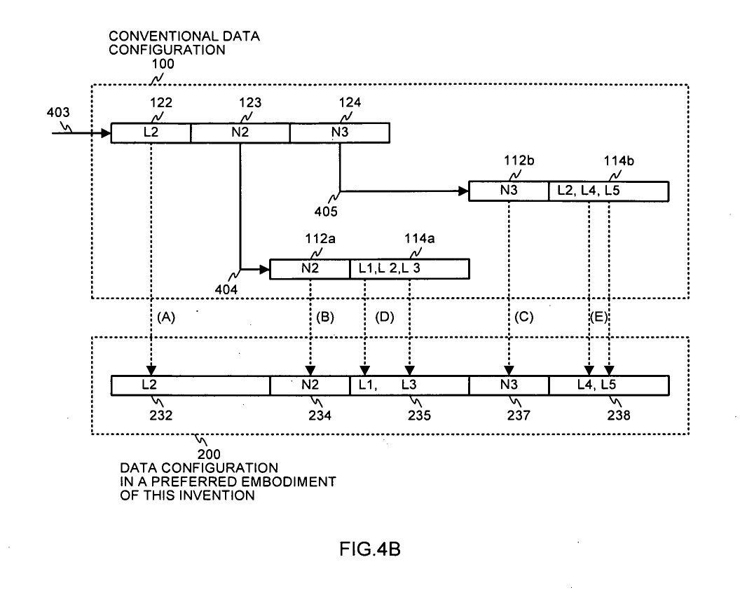

FIG. 4A is a drawing describing an example of a data configuration that represents a network in one preferred embodiment of this invention. Descriptions of cost are omitted. As shown in the drawing, link destination table 309a contains columns for link IDs 232, for node IDs 234 that are nodes on one side of a link, for destination link IDs 235 for a node on one side of a link, for node IDs 237 that are the nodes on the other side of the link, and for the destination link IDs 238 for a node on the other side of the link.

The values in each column are those corresponding to the values illustrated in the network configuration shown in FIG. 1A. For L1 in link ID 232, N1 is stored in the node ID 234 for a node on one side, N2 is stored in the node ID 237 for the node on the other side, L2 and L3 are stored in destination link IDs 238 for the node on the other side, and nothing is stored in the destination link IDs 235 for the node on one side.

For L2 in link ID 232, N2 is stored in the node ID 234 for a node on one side, L1 and L3 are stored in destination link IDs 235 for a node on one side, N3 is stored in the node ID 237 for the node on the other side, and L4 and L5 are stored in destination link IDs 238 for the node on the other side.

Hereinbelow, in the same way, for each of L3, L4, L5, L6, L7, and L8 in link ID 232 respectively, the node ID 234 for a node on one side contains N2, N3, N3, N4, N4, and N5, the destination link IDs 235 for a node on one side contains L1 and L2, L2 and L5, L2 and L4, L3 and L4 and L7, L3 and L4 and L6, and L5 and L6, the node ID 237 for a node on the other side contains N4, N4, N5, N5, N6, and N6, and the destination link IDs 238 for a node on the other side contains L4 and L6 and L7, L3 and L6 and L7, L6 and L8, L5 and L8, L8, and L7.

FIG. 4B is a drawing describing the concept of generating network representation data from conventional network representation data in one preferred embodiment of this invention. The conventional data configuration 100 shown in the drawing shows a partial extraction of the rows in link table 121 and intersection table 111 shown in FIG. 1B. In the example shown in FIG. 4B, the arrow 403 shows that the row with L2 in its link ID 122 is extracted from link table 121.

The data configuration 200, in one preferred embodiment of this invention, is the row whose link ID 232 is L2 in link connection table 309a shown in FIG. 4A. As shown by the dotted-line arrow (A) from link ID 122 in conventional data configuration 100, a link ID with the same link ID as the link ID 122 in the conventional data configuration 100 is set in the link ID 232 of the data configuration 200 in one preferred embodiment of this invention.

As shown by arrow 404, the line whose node ID 123 for a node on one side in conventional data configuration 100 contains N2 is extracted from the intersection table 111, and the N2 in node ID 112a, as shown by the dotted-line arrow (B), and, of the link IDs 114a, L1 and L3, which are not the same as the link in link ID 122, as shown by the dotted-line arrow (D), are respectively set in the node ID 234 for a node on one side and in the destination link IDs 235 for a node on one side, in the data configuration 200 of one preferred embodiment of this invention.

In the same way, as shown by the arrow 405, the line whose node ID 124 for a node on the other side in conventional data configuration 100 contains N3 is extracted from the intersection table 111, and the N3 in node ID 112b, as shown by the dotted-line arrow (C), and, of the link IDs 114b, L4 and L5, which are not the same as the link in link ID 122, as shown by the dotted-line arrow (E), are respectively set in the node ID 237 for a node on the other side and in the destination link IDs 238 for the node on the other side, in the data configuration 200 of one preferred embodiment of this invention.

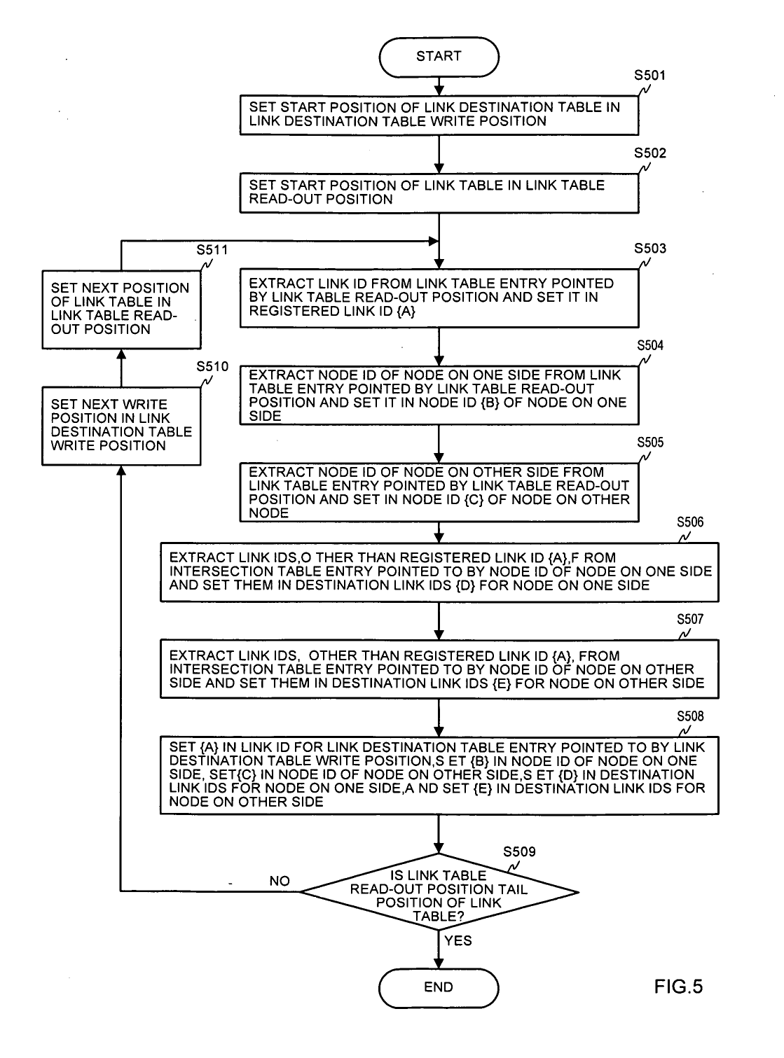

FIG. 5 is a drawing describing an example of the processing for generating a data configuration that represents a network in one preferred embodiment of this invention. Hereinbelow, the processing is described referencing the examples shown in FIG. 1A, FIG. 1B, FIG. 4A, and FIG. 4B.

First, at step S501, the link destination table start position is set in the link destination table write position. In the example shown in FIG. 4A, the line with link L1 in link ID 232j in the link destination table 309a is the start of the table and its line is set in the start position. Here, the link destination table write position is one of the “temporary memory areas that can be used to enable various values obtained during processing to be used in subsequent processing” that was noted above, and is an unillustrated temporary work area for setting the link destination table write position. In the description hereinbelow, unillustrated temporary memory areas may be named by the data contents stored or set in them just like the above noted link destination table write position.

Next, at step S502, the link table start position is set in the link table read-out position. In the example shown in FIG. 1A and FIG. 1B, the line whose link ID 122 in link table 121 is L1 is set as the start position.

Next, proceeding to step S503, the link ID is extracted from the link table entry pointed to by the link table read-out position and is set in link ID, which is a temporary memory area (called A in the description for FIG. 5 below). In the example shown in FIG. 4B, L2 is in link ID 122 at the link table read-out position, as shown by arrow 403, and L2 is set in A.

Next, proceeding to step S504, the node ID on one side is read out from the link table entry pointed to by the link table read-out position and is set in the node ID on one side, which is a temporary memory area (called B in the description for FIG. 5 below). In the example shown in FIG. 4B, the node ID on one side 123 at the link table read-out position is N2, and N2 is set in B.

Next, proceeding to step S505, the node ID of the other node is read out from the link table entry pointed to by the link table read-out position and is set in node ID on the other side, which is a temporary memory area (called C in the description for FIG. 5 below). In the example shown in FIG. 4B, the node ID on the other side 124 at the link table read-out position is N3, and N3 is set in C.

Next, proceeding to step S506, the link IDs other than A are read out from the intersection table entry pointed to by B and are set in the link IDs connected to a node on one side, which is a temporary memory area (called D in the description for FIG. 5 below). In the example shown in FIG. 4B, the link IDs in the intersection table entry pointed to by N2, which is set in B, are L1, L2, and L3, as shown by the arrow 404, and excluding the L2 that is set in A, L1 and L3 are set in D.

Next, proceeding to step S507, the link IDs other than A are read out from the intersection table entry pointed to by C and are set in the link IDs connected to a node on the other side, which is a temporary memory area (called E in the description for FIG. 5 below). In the example shown in FIG. 4B, the link IDs in the intersection table entry pointed to by N3, which is set in C, are L2, L4, and L5, as shown by the arrow 404, and excluding the L2 that is set in A, L4 and L5 are set in E.

Next, in step S508, for the link destination table entry pointed to by the link destination table write position, A is set in the link ID, B is set in the node ID on one side, C is set in the node ID on the other side, D is set in the destination link IDs for the node on one side, and E is set in the destination link IDs for the node on the other side, respectively. In the example shown in FIG. 4B, the link ID 232 at the link destination table write position corresponding to the arrow 403 contains the L2 set in A, the node ID on one side 234 contains the N2 set in B, the destination link IDs 235 for a node on one side contain L1 and L3 set in D, the node ID on the other side 237 contains the N3 set in C, and the destination link IDs 238 for the node on the other side contain L4 and L5 set in E, respectively.

Next, in step S509, a determination is made whether link table read-out position is the last position in the link table. If it is not the last position, at step S510, the next write position is set in the link destination table write position, and at step S511, the next read-out position is set in the link table read-out position, processing returns to step S503, and the processing of steps S503 to S509 is repeated.

Conversely, when the determination at step S509 is that the link table read-out position is the last position in the link table, processing is terminated because the link destination table has been completed. Of the processing flow noted above, steps S502 to S511 can be executed by the data configuration reading means 201 shown in FIG. 2A, and steps S501 to S508 can be executed by the link destination table generating means 202 shown in FIG. 2A. Also, the correspondence between the above noted processing flow and the execution means for each step is merely a simple example and it is clear that various modifications are possible.

Although the data used to generate the link destination table can be deleted because the link destination table is generated in the above processing, in the path finding processing described next, for convenient search processing of the links connected to the path finding origin point, it is preferable to keep the intersection table.

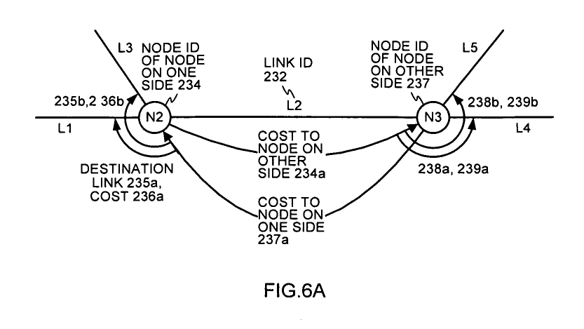

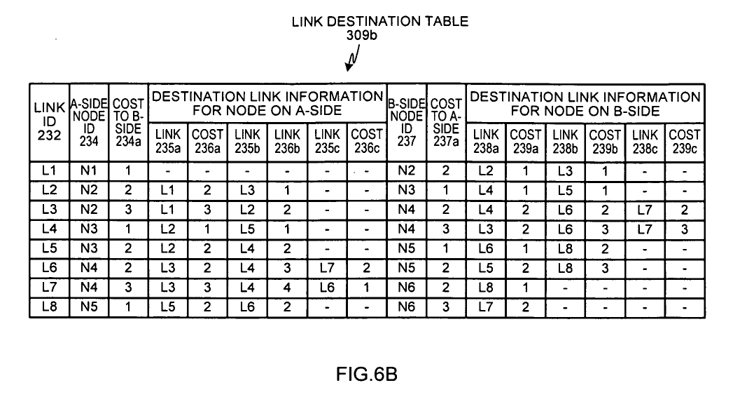

Hereinbelow an example is described of cost setting in a network search in one preferred embodiment of this invention, referencing FIG. 6A and FIG. 6B. What is shown in FIG. 6A is, of the nodes and links in the exemplary network configuration shown in FIG. 1 A, the concept of the costs related to nodes N2 and N3 and the links L1, L2, L3, L4, and L5 connected to them respectively, in one preferred embodiment of this invention.

As shown in FIG. 6A, when the link ID 232 in the link destination table is taken to be L2, the node ID 234 for the node on one side (the node on the A side) is N2, and the node ID 237 for the node on the other side (B-side node) is N3. Then the cost 234a to the node on the other side from node N2 to node N3 and the cost 237a to the node on the one side from node N3 to node N2 is defined for link L2. This cost is called the interval cost.

In one embodiment of this invention, in addition to this interval cost, the connection costs of the links to the A-side and to the B-side are defined. The description below of the preferred embodiment assumes the definition of connection costs. As shown in the drawing, the connection cost 236a from the link whose link ID 232 is L2 to the destination link whose destination link ID 235a for the node on one side is L1, and the connection cost 236b to the destination link whose destination link ID 235b for the node on one side is L3 is defined on the A-side. In the same way, the connection cost 239a to the destination link whose destination link ID 238a for the node on the other side is L4, and the connection cost 239b to the destination link whose destination link ID 238b for the node on the other side is L5 is defined on the B-side.

FIG. 6B shows link destination table 309b, which is the link destination table 309a exemplified in FIG. 4A, to which the above noted interval costs and connection costs have been added. As an example of the costs to the B-side 234a for link IDs 232 with the links L1 to L8 the costs are 1, 2, 3, 1, 2, 2, 3, and 1, and as an example of the costs to the A-side 237a the costs are 2, 1, 2, 3, 1, 2, 2, and 3.

Also, the connection cost 236a to link 235a, the connection cost 236b to link 235b, and the connection cost 236c to link 235c are set as the destination link information for the A-side node. In the same way, the connection cost 239a to link 238a, the connection cost 239b to link 238b, and the connection cost 239c to link 238c are set as the destination link information for the B-side node.

However, because N1, which is the A-side node of link L1, is a destination point on one side of the connections in the network, nothing is set in the destination link IDs 235 of the node on one side for link L1 in the link destination table 309a shown in FIG. 4A, and thus destination link information of the A-side node corresponding to link L1 in the link destination table 309b is not set. As for the destination link information for the B-side node of link L1, 1 is set in its connection cost to link L2 and 1 is set in the connection cost to link L3.

As for link L2, 2 is set in the connection cost to link L1, and 1 is set in the connection cost to link L3 as the destination link information for its A-side nodes; and 1 is set in the connection cost to link L4, and 1 is set in the connection cost to link L5 as the destination link information for its B-side nodes.

As for link L3, 3 is set in the connection cost to link L1, and 2 is set in the connection cost to link L2 as the destination link information for its A-side nodes; and 2 is set in the connection cost to link L4, 2 is set in the connection cost to link L6, and 2 is set in the connection cost to link L7 as the destination link information for its B-side nodes.

As for link L4, 1 is set in the connection cost to link L2, and 1 is set in the connection cost to link L5 as the destination link information for its A-side nodes; and 2 is set in the connection cost to link L3, 3 is set in the connection cost to link L6, and 3 is set in the connection cost to link L7 as the destination link information for its B-side nodes.

As for link L5, 2 is set in the connection cost to link L2, and 2 is set in the connection cost to link L4 as the destination link information for its A-side nodes; and 1 is set in the connection cost to link L6, and 2 is set in the connection cost to link L8 as the destination link information for its B-side nodes.

As for link L6, 2 is set in the connection cost to link L3, 3 is set in the connection cost to link L4, and 2 is set in the connection cost to link L7 as the destination link information for its A-side nodes; and 2 is set in the connection cost to link L5, and 3 is set in the connection cost to link L8 as the destination link information for its B-side nodes.

As for link L7, 3 is set in the connection cost to link L3, 4 is set in the connection cost to link L4, and 1 is set in the connection cost to link L6 as the destination link information for its A-side nodes; and 1 is set in the connection cost to link L8 as the destination link information for its B-side nodes.

As for link L8, 2 is set in the connection cost to link L5, and 2 is set in the connection cost to link L6 as the destination link information for its A-side nodes; and 2 is set in the connection cost to link L7 as the destination link information for its B-side nodes.

As was noted above, by enabling costs to be separated into interval costs and connection costs, an actual, more detailed physical network can be simulated.

For example if a road network is being modeled, conditions relatively unique to roads themselves such as road lane width or speed restrictions can be reflected in the interval cost and traffic conditions between two roads such as right-turn interdiction or the existence of right-turn signals and so forth can be reflected in the connection cost, and so forth.

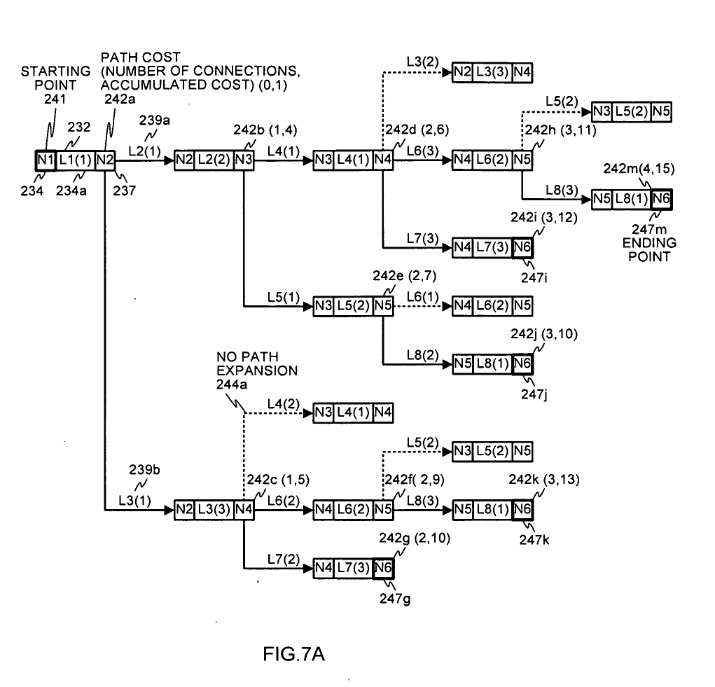

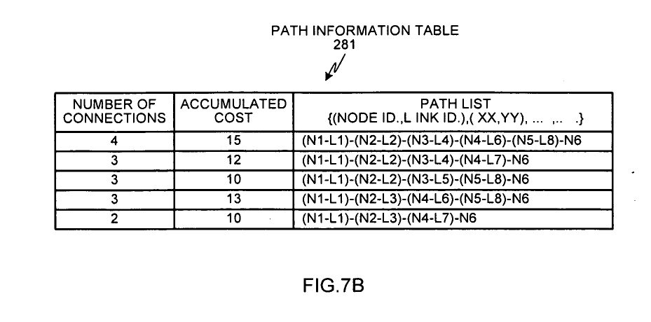

Hereinbelow the concept of a network path finding in one preferred embodiment of this invention is described, referencing FIG. 7A and FIG. 7B. FIG. 7A shows all the paths expanded in a path finding with node N1 of network 1 shown in the example in FIG. 1 A as its origin point and node N6 as its destination point, and FIG. 7B shows the path information table generated in the above noted path finding.

Because the paths from the origin point node to the destination point node can be expressed as the string of links connecting those two nodes, path expansion can be expressed in a tree form with the first link, L1, as its root and its destination links as lower level nodes. When this tree is made into a path expansion tree, FIG. 7A shows such a path expansion tree, wherein, for the links in a path nodes (called at times a path expansion node) are prepared with the A-side node ID 234, the link ID 232, the cost 234a to the B-side, and the B-side node ID 237 and branches (called at times path expansion branches) are prepared with the connection cost to a link included in a lower level path. Thus a network path finding corresponds to generating a path expansion tree and searching for an optimal path from among the generated paths.

As shown in FIG. 7A, node N1 is specified as the origin point 241, and L1 is selected from the link destination table 309b as the link ID 232 that has node ID N1 as its node ID 234 for a node on one side (A-side node), and cost 234a to the B-side is extracted from the link destination table 309b entry pointed to by link ID L1, and furthermore N2 is read-out as the node ID 237 in the B-side node, and the root node of the path expansion tree is generated. The values (0, 1) are computed and attached to B-side node N2 as the path cost 242a (number of connections, accumulated cost) up to N2.

Next, 1 is read out as the connection cost 239a to link L2 from the start of the B-side node destination link information in the link destination table 309b entry pointed to by the link ID L1, and a path expansion branch with connection cost L2 (1) appended is generated, as shown by the solid-line arrow. Then N2 is read out as the A-side node ID 234 from the link destination table 309b entry pointed to by link. ID L2 and 2 is read out as the cost to the B-side 234a, and furthermore N3 is read out as B-side node ID 237, (1, 4) is computed as the path cost 242b to N3, and the path expansion node corresponding to link L2 is generated. Here, the accumulated cost 4 is that wherein the connection cost 1 from link L1 to link L2 and the interval cost 2 for link 2 are added to the accumulated cost 1 for node N2.

Also, in the same way, 1 is read out as the connection cost 239b to link L3 from the B-side node next destination link information in the link destination table 309b entry pointed to by link ID L1, and 3 is extracted from the link destination table 309b entry pointed to by link ID L3 as the cost 234a to the B-side, and N4 is read out as the node ID 237 of the B-side node, and (1, 5) is computed as the path cost 242c to N4.

In the path on the link L2 side, 1 is read out as the connection cost 239a to link L4 from the B-side node destination link information in the link destination table 309b entry pointed to by the link ID L2, and 1 is extracted as the cost 234a to the B-side from the link destination table 309b entry pointed to by the link ID L4, and N4 is read out as the node ID 237 of the B-side node, and (2, 6) is computed as the path cost 242d to N4.

Also, in the same way, in the path on the link L2 side, 1 is read out as the connection cost 239b to link L5 from the B-side node destination link information in the link destination table 309b entry pointed to by link ID L2, and 2 is extracted as the cost 234a to the B-side from the link destination table 309b entry pointed to by link ID L5, and N5 is read out as the node ID 237 of the B-side node, and (2, 7) is computed as the path cost 242e to N5.

Also, in the path on the link L3 side, 2 is read out as the connection cost 239a to link L4 from the node destination link information for the B-side in the link destination table 309b entry pointed to by link ID L3, and 1 is extracted as the cost 234a to the B-side from the link destination table 309b entry pointed to by link ID L4, and N4 is read out as the node ID 237 of the B-side node.

Regarding this connection to link L4, because the node ID set in B-side node ID 237 for the link destination table 309b entry pointed to by link ID L4 is N4 and the path returns again to the B-side node N4 for connection source link L3 and thus it is clear that this path is an unnecessary path for computing the minimum path, so at this point path expansion is aborted, as shown by the dotted-line arrow 244a that indicates no further path expansion. Also, because either the A-side node or the B-side node of the destination link coincides with the B-side node of the link that is the source of the connection and the A-side node and the B-side node in the same link cannot match, the determination to abort path expansion can be made when the A-side node of the destination link does not coincide with the B-side node of the link that is the source of the connection.

In the same way, in the paths on the link L3 side, 2 is read out as the connection cost 239b to link L6 from the node destination link information for the B-side in the link destination table 309b entry pointed to by link ID L3, and 2 is extracted as the cost 234a to the B-side from the link destination table 309b entry pointed to by link ID L6, and N5 is readout as the node ID 237 of the B-side node, and [2, 9] is computed as the path cost 242f to N5.

Also, in the same way, in the paths on the link L3 side, 2 is read out as the connection cost 239c to link L7 from the node destination link information for the B-side in the link destination table 309b entry pointed to by link ID L3, and 3 is extracted as the cost 234a to the B-side from the link destination table 309b entry pointed to by link ID L7, and N6 is readout as the node ID 237 of the B-side node, and (2, 10) is computed as the path cost 242g to N6. As shown in the drawing, node N6 is the destination point 247g based on the path links L1, L3, and L7.

Also, in the link L2-L4 paths, 2 is read out as the connection cost 239a to link L3 from the node destination link information for the B-side in the link destination table 309b entry pointed to by link ID L4, and 3 is read out as the cost 234a to the B-side from the node destination link information for the B-side in the link destination table 309b entry pointed to by link ID L3, and N4 is readout as the node ID 237 of the B-side node. Thus, because the path returns to the B-side node N4 of link L4, the computation of the path cost is not made and the expansion of the path is aborted.

In the same way, in the link L2-L4 paths, 3 is read out as the connection cost 239b to link L6 from the node destination link information for the B-side in the link destination table 309b entry pointed to by link ID L4, and 2 is extracted as the cost 234a to the B-side from the link destination table 309b entry pointed to by link ID L6, and N5 is readout as the node ID 237 of the B-side node, and (3, 11) is computed as the path cost 242h to N5.

Also, in the same way, in the link L2-L4 paths, 3 is read out as the connection cost 239c to link L7 from the node destination link information for the B-side in the link destination table 309b entry pointed to by link ID L4, and 3 is extracted as the cost 234a to the B-side from the link destination table 309b entry pointed to by link ID L7, and N6 is readout as the node ID 237 of the B-side node, and (3, 12) is computed as the path cost 242i to N6.

As shown in the drawing, node N6 is the destination point 247i based on the path links L1, L2, L4, and L7.

Also, in the link L2-L5 paths, 1 is read out as the connection cost 239a to link L6 from the node destination link information for the B-side in the link destination table 309b entry pointed to by link ID L5, and 2 is extracted as the cost 234a to the B-side from the link destination table 309b entry pointed to by link ID L6, and N5 is readout as the node ID 237 of the B-side node. Thus because the path returns to the B-side node N5 of link L5, the computation of the path cost is not made and the expansion of the path is aborted.

In the same way, in the link L2-L5 paths, 2 is read out as the connection cost 239b to link L8 from the node destination link information for the B-side in the link destination table 309b entry pointed to by link ID L4, and 1 is extracted as the cost 234a to the B-side from the link destination table 309b entry pointed to by link ID L8, and N6 is readout as the node ID 237 of the B-side node, and (3, 10) is computed as the path cost 242j to N6. As shown in the drawing, node N6 is the destination point 247j based on the path links L1, L2, L5, and L8.

Also, in the link L3-L6 paths, 2 is read out as the connection cost 239a to link L5 from the node destination link information for the B-side in the link destination table 309b entry pointed to by link ID L6, and 2 is extracted as the cost 234a to the B-side from the link destination table 309b entry pointed to by link ID L5, and N5 is readout as the node ID 237 of the B-side node. Thus because the path returns to the B-side node N5 of link L6, the computation of the path cost is not made and the expansion of the path is aborted.

In the same way, in the link L3-L6 paths, 3 is read out as the connection cost 239b to link L8 from the node destination link information for the B-side in the link destination table 309b entry pointed to by link ID L8, and 1 is extracted as the cost 234a to the B-side from the link destination table 309b entry pointed to by link ID L8, and N6 is readout as the node ID 237 of the B-side node, and (3, 13) is computed as the path cost 242k to N6. As shown in the drawing, node N6 is the destination point 247k based on the path links L1, L3, L6, and L8.

Also, in the link L2-L4-L6 paths, 2 is read out as the connection cost 239a to link L5 from the node destination link information for the B-side in the link destination table 309b entry pointed to by link ID L6, and 2 is extracted as the cost 234a to the B-side from the link destination table 309b entry pointed to by link ID L5, and N5 is readout as the node ID 237 of the B-side node. Thus because the path returns to the B-side node N5 of link L6, the computation of the path cost is not made and the expansion of the path is aborted.

In the same way, in the link L2-L4-L6 paths, 3 is read out as the connection cost 239b to link L8 from the node destination link information for the B-side in the link destination table 309b entry pointed to by link ID L6, and 1 is extracted as the cost 234a to the B-side from the link destination table 309b entry pointed to by link ID L8, and N6 is readout as the node ID 237 of the B-side node, and (4, 15) is computed as the path cost 242m to N6. As shown in the drawing, node N6 is the destination point 247m based on the path links L1, L2, L4, L6, and L8.

By the above processing, all of the paths from node N1 to node N6 are expanded, and their number of connections, accumulated cost, and path list are stored in the path information table 281 shown in FIG. 7B. The path information table shows that 4, 3, 3, 3, and 2 are stored as the number of connections and 15, 12, 10, 13, 10 are stored as the accumulated cost, corresponding to the destination points 247m, 247i, 247j, 247k, and 247g shown in FIG. 7A. Also, the path list, which is a combination of the node ID of the A-side node and the link ID, contains information corresponding to the paths expanded in FIG. 7A.

Also, in the above description of path expansion, although the paths through the path expansion tree are described, layer by layer, from each of the higher level layers to the lower level layers, the path expansion tree can also be generated by giving priority to destination link information stored in link destination table 309b for B-side nodes with positions on the upper right side in the path expansion tree. The path information stored in the path information table shown in FIG. 7B is that by which the path expansion tree is generated using this latter sequence (depth priority).

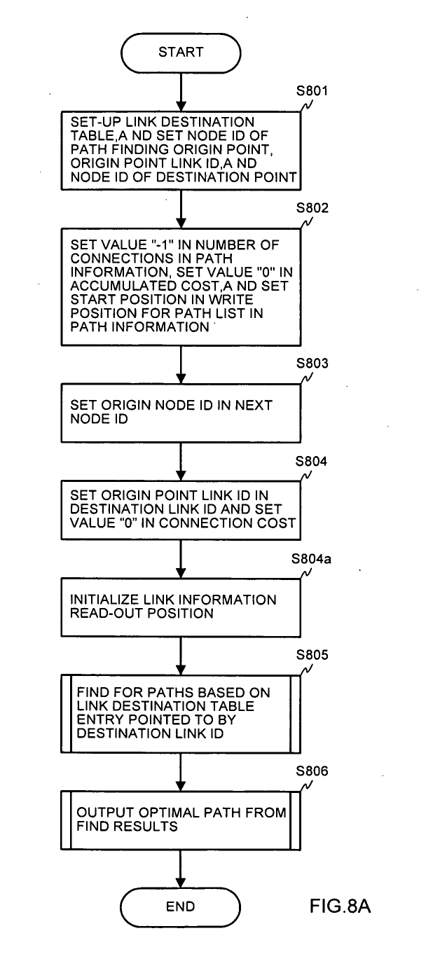

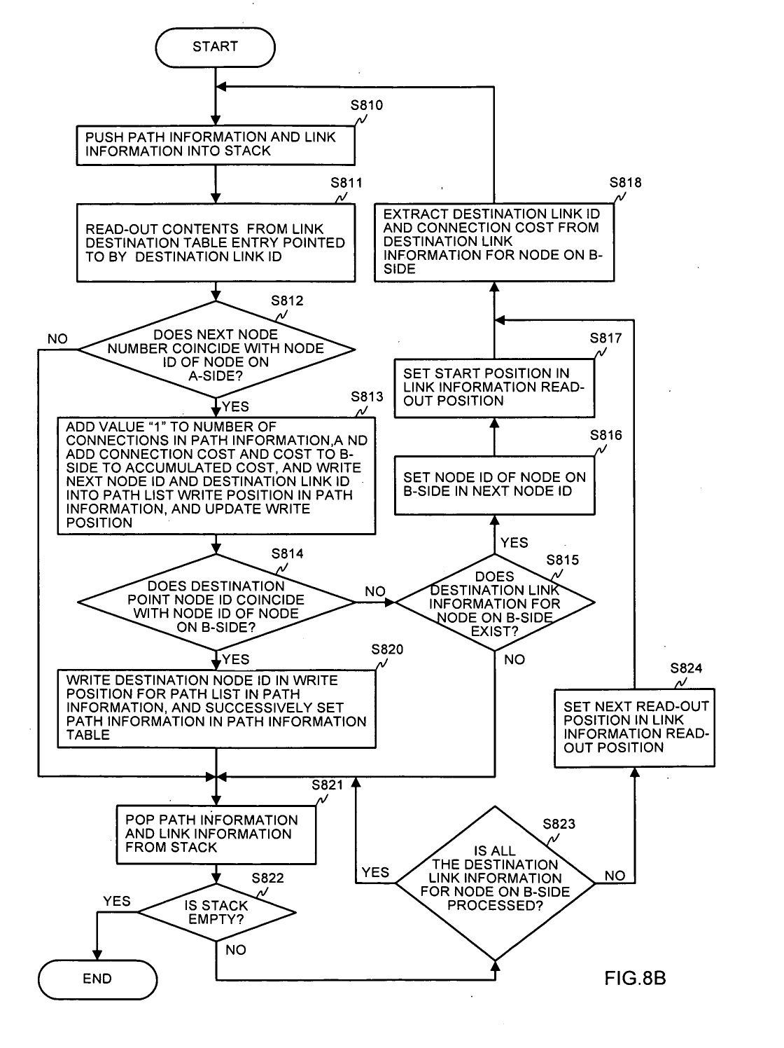

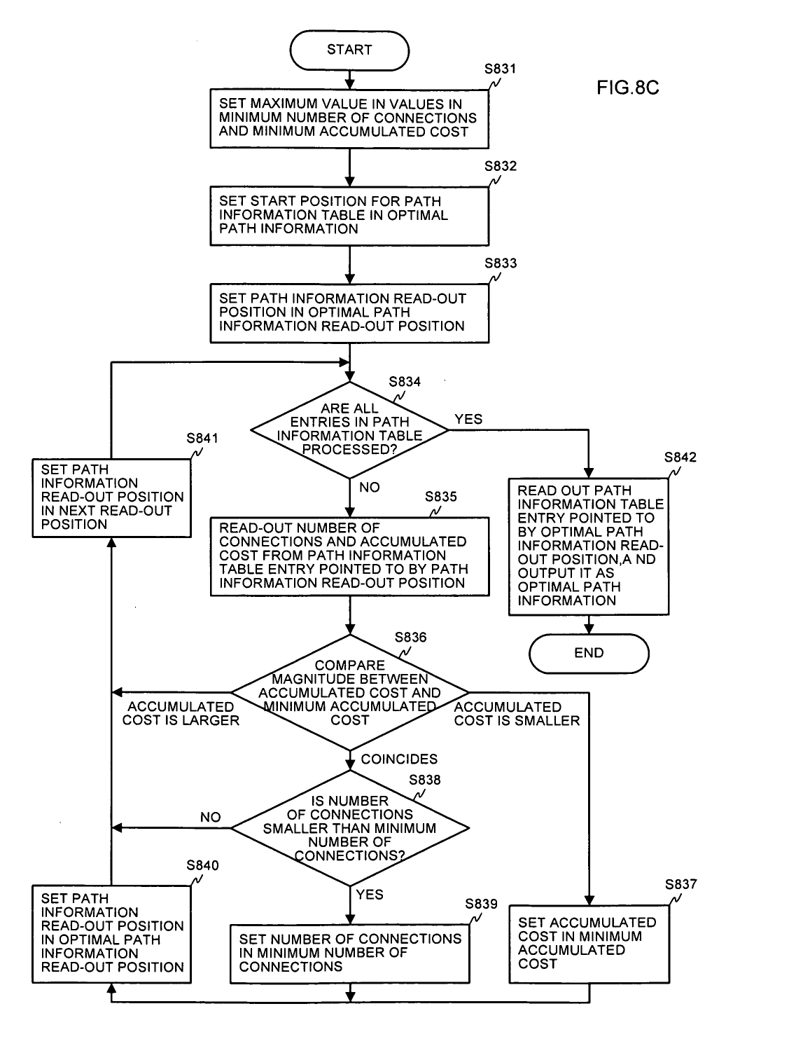

Hereinbelow, the processing to search for an optimal network path in one preferred embodiment of this invention is described referencing FIG. 8A to FIG. 8C. In this description, the right side of the path expansion tree is given priority in the generation.

FIG. 8A is a drawing describing an example of an overview of the processing to search for an optimal path in a network in one preferred embodiment of this invention. Hereinbelow, a concrete example is described arbitrarily referencing the network configuration example shown in FIG. 1A, the link destination table 309b shown in FIG. 6B, the path information table 281 shown in FIG. 7B and so forth. In those cases, expressions such as “in the concrete example” and so forth may be used.

First, in step S801, the link destination table, the path finding origin point node ID, the origin point link ID, and the destination point node ID are set up. In the setup of the link destination table, its start address and size can be set, for example, by specifying the name of a link destination table from outside a system. Also, in the setting of the origin point link ID, the link ID of the link connected to the origin point node may even be set from the intersection table, as was noted above. In the concrete example, N1 is set in the origin point node ID, L1 is set in the origin point link ID, N6 is set in the destination point node ID, and link destination table 309b is set in the link destination table.

Next, in step S802, in the path information, the value “−1” is set in the number of connections and the value “0” is set in the accumulated cost, the start position is set in the write position for a path list, and at step S803, the origin point node ID is set in the next node ID.

Furthermore, at step S804, the origin point link ID is set in the destination link ID and the value “0” is set in the connection cost, and at step S804a, the read-out position of the link information is initialized and processing proceeds to step S805. In the concrete example, N1 is set in the next node ID and L1 is set in the destination link ID.

At step S805, a path finding is made based on the link destination table entry pointed to by destination link ID, and processing proceeds to step S806. Details of the processing in step S805 is described later referencing FIG. 8B.

At step S806, the optimal path is output from the search results obtained in step S805, and processing is terminated. Details of the processing in step S806 is described later referencing FIG. 8C.

Also, if there are a plurality of links connected to the origin point node, the above processing obtains optimal paths using each of those links as the origin point link, and it is clear to one skilled in the art that the optimal path can be obtained from among those paths.

FIG. 8B is a drawing showing the details of the processing flow in step S805 shown in FIG. 8A and it describes the processing flow for a network path finding in one preferred embodiment of this invention.

As shown in the drawing, in step S810, path information and link information are pushed into a stack. Here, what is meant by path information is the number of connections, the accumulated cost, the path list, and their write position; and what is meant by link information is the next node ID, the destination link ID, the connection cost, the contents of the link destination table pointed to by the destination link ID, and the read-out position of the link information in the link destination table. In the first processing of step S810, the contents set in steps S801 to S804a shown in FIG. 8A are pushed into the stack.

Next, at step S811, the contents of the link destination table entry pointed to by the destination link ID are read out as a destination link information. In the initial processing of the concrete example, the contents of the line whose link ID 232 is L1, which line is the first in link destination table 309b are read out because L1, which is the origin point link ID, is set in the destination link ID in step S804 shown in FIG. 8A.

Next, in step S812, a determination is made whether the next node ID coincides with the A-side node ID of the link destination table entry read-out at step S811. If they coincide, processing proceeds to step S813 and if they do not coincide processing branches to step S821. In the initial processing of the concrete example, because the A-side node ID 234 is N1 and because N1, which is the origin point node ID set at step S803 shown in FIG. 8A, is set in the next node ID, they are determined to coincide and processing proceeds to step S813. The case where the determination is that they do not coincide is the case wherein, of the path expansions shown in FIG. 7A, there is no path expansion, as shown by the dotted-line arrows.

At step S813, 1 is added to the connection number in the path information, and the connection cost and the cost to the node on the B-side in the link destination table read out at step S811 are added to the accumulated cost, and the next node ID and the destination link ID are written in the write position in the path list in the path information, and the write position is updated. The connection cost at this point is either that initially set at step S804 shown in FIG. 8A or that set at step S818 described below. Also, the path information is a temporary memory area holding a single full line of the path information table 281 shown in FIG. 7B. In the initial processing of the concrete example, the values “−1” and “0” are the initial settings for the connection number and accumulated cost, respectively, of the path information set at step S802 shown in FIG. 8A, and the number of connections and the accumulated cost in the path information are 0 and 1 respectively because 1 is stored in the cost 234a to the node on the B-side at the read-out position in the link information initialized in the link destination table. Also, the next node ID N1 and the destination link ID L1 initialized at steps S802 and S803 shown in FIG. 8A are written in the start position for the path list in the path information.

Next, proceeding to step S814, a determination is made whether the node ID on the B-side in the link destination table read-out at step S811 coincides with the destination point node ID and when the determination is that the B-side node ID does not coincide with the destination point node ID, processing branches to step S815. At step S815 a determination is made whether destination link information exists for the B-side node. The purpose of this determination is to enable a branch to step S821 described below when there is a dead-end link in the path because there is no destination link information for that B-side node and thus as was noted above the path cannot be expanded.

Conversely, when the determination at step S815 is that destination link information exists, processing proceeds to S816, wherein the node ID on the B-side is set in the next node ID, and in step S817 the start position of the destination link information for the B-side node in link destination table is set in the link information read-out position. The setting of this read-out position in the link information decides the direction priority for the path finding, and as was described for the path finding tree in the concrete example, paths are sought by prioritizing the [upper] right side of the tree.

Following step S817, at step S818, the destination link ID and the connection cost are extracted from the destination link information for the B-side node. In the initial processing of the concrete example, L2 and 1, stored therein as link 238a and cost 239a, are extracted from the destination link information of the B-side node and are set in the destination link ID and the destination cost, and processing returns to step S810.

The processing loop of the above steps S810 to S818 is repeated until the determination at step S812 is that the next node ID does not coincide with the A-side node ID (hereinbelow this may be called the pruning determination) or the determination at step S814 is that destination point node ID coincides with the B-side node ID (hereinbelow this may be called the destination point determination) or the determination at step S818 is that destination link information does not exist (hereinbelow this may be called a dead-end determination).

When the determination at step S814 is a destination point determination, processing proceeds to step S820 wherein the destination point node ID is written in the write position in the path list of the path information and path information is successively written in the path information table, and processing proceeds to step S821. Here, successively writing path information into the path information table means writing the path information up to a destination point node into the path information table while changing the table line successively for each destination point.

At step S821, path information and link information is popped from the stack and processing proceeds to step S822. In the processing loop of steps S810 to S818, the path information and link information is pushed into the stack at step S810. In other words, each time a path expansion node is generated for the path expansion tree the path information and link information for the generated path expansion node are pushed in the stack.

And in the above processing loop, the steps S811 and thereafter process a path expansion node lower than the path expansion node, whose path information and link information were pushed into the stack, and because the pruning determination, the destination point determination or the dead-end determination are also performed for the lower path expansion node, the path information and link information popped in the processing executed at step S821, reached by branching from the above noted processing loop, is related to the higher level path expansion node for the path expansion node for which pruning determination, destination point determination or dead-end determination was performed.

At step S822, a determination is made whether the stack is empty, and if it is empty, processing is terminated because path expansion has been completed, and if it is not empty, processing proceeds to step S823. In the example shown in FIG. 7A the determination that the stack is empty at step S822 happens when the path expansion reaches destination point 247g.

At step S823, a determination is made whether all the destination link information of the B-side node in the link destination table popped at step S821 is completely processed. If the information is completely processed, a return is made to step S821 and once more path information and link information for a path expansion node 1 level higher is popped from the stack. If the information is not completely processed, processing proceeds to step S824 and the next read-out position is set in the read-out position in the link information and proceeding to step S818, processing merges with the above noted processing loop.

By the above processing, all the paths are expanded from the origin point node to the destination point node and path information is generated up to the destination point node.

Also, although the above description took a node ID of an A-side node in the link destination table as the origin point node, it is clear that, if a node ID of a B-side node in the link destination table is taken as the origin point node, it is sufficient to replace the words “A-side” in the above description with “B-side” and to replace the words “B-side” in the above description with “A-side”.

Also, although path information and link information were described as being kept in a stack during path expansion, if the path information and link information during path expansion are stored in a format enabling identification of which level they are at, the keeping of path information and link information during path expansion is not restricted to a stack.

FIG. 8C is a drawing describing an example of the processing flow to determine an optimal path in one preferred embodiment of this invention. The description continues with appropriate references to the path information table 281 shown in the example in FIG. 7B.

As shown in the drawing, at step S831, the maximum value (all 1's in the bit values) is set in the values for the minimum connection number and minimum accumulated cost. Also, at step S832, the start position for the path information table is set in the read-out position for the path information. Next, at step S833, the start position for the path information table is set in the read-out position for the optimal path information. In the example shown in FIG. 7B, the position of the path information corresponding to the destination point 247m is initially set in the read-out position for the path information and in the read-out position for the optimal path information.

Next, proceeding to step S834, a determination is made whether the whole path information table has been processed. If it has been processed, in step S835, the connection number and accumulated cost are read out from the path information table entry pointed to by the read-out position for the path information. Next, at step S836, a magnitude comparison is made between the read-out accumulated cost and the minimum accumulated cost, and if the accumulated cost is smaller than the minimum accumulated cost a branch is made to step S837, wherein the accumulated cost read out at step S835 is set in the minimum accumulated cost. In the initial determination processing in step S836, because the maximum value has set in the minimum accumulated cost at step S831, a branch is made to step S837, and the accumulated cost for the start position in the path information table is set in the minimum accumulated cost, and processing proceeds to step S840.

Conversely, if the accumulated cost coincides with the minimum accumulated cost, processing proceeds from step S836 to step S838, wherein furthermore a determination is made whether the connection number is smaller than the minimum connection number. If the determination result in step S838 is “Yes”, at step S839, the connection number is set in the minimum connection number, and processing proceeds to step S840.

At step S840, the read-out position for the path information is set in the read-out position for the optimal path information, and processing proceeds to step S841.

If the determination result in step S838 is “No”, processing proceeds to step S841.

Also, at step S836, when a determination is made that the accumulated cost is larger than the minimum accumulated cost, processing proceeds to step S841.

At step S841, the read-out position for the path information is set in the next read-out position and a return is made to step S834.

At the above noted step S834, when the determination is made that the path information table has been completely processed, in step S842, the path information table entry pointed to by the read-out position for the optimal path information is read out and is output as the optimal path information and processing is terminated.

Although the foregoing is a detailed description of a preferred embodiment of the present invention, the embodiments of the present invention are not limited in this manner, and it will be clear to a person skilled in the art that a variety of modifications thereof are possible.

It is also clear that the network path finding apparatus of the present invention can be implemented on a computer by means of a program that executes on that computer the means for storing a link destination table and the processing shown in FIG. 8A to FIG. 8C.

Furthermore, it is clear that the data configuration generation method of this invention can be implemented by a program that a computer is caused to execute that generates the data configuration for a path finding shown in FIG. 5, and its equivalents. And by those programs the means for generating a data configuration and so forth of this invention can be implemented on a computer.

Therefore, the above-noted programs, and a computer-readable storage medium into which the programs are stored are encompassed by the embodiments of the present invention.

Also, a computer-readable storage medium into which are stored the data configuration for a path finding in this invention and the data using that data configuration are encompassed by the embodiments of the present invention.

As was explained in the details above, when using a link destination table, which is a new data configuration provided by this invention, an efficient network path finding can be enabled.

Although this invention is not limited to such an application, it will have a major effect when it is applied to an optimal path finding in an appliance embedding a small computer like a car navigation appliance.

What is claimed is:

1. A network path finding apparatus for finding paths in a network consisting of nodes and links that connect between two nodes of the nodes, and outputting an optimal path, comprising:
a link destination table that contains, for link IDs identifying each link in the network,
a node ID of a node on one side that identifies the node on one side of each of the links, and
destination link IDs for the node on one side that are link IDs identifying all of other links connected to the node on one side, and
a node ID of a node on the other side that identifies the node on the other side of each of the links, and
destination link IDs for the node on the other side that are link IDs identifying all of other links connected to the node on the other side, and
interval costs that are a cost from the node on one side to the node on the other side of each link and a cost from the node on the other side to the node on one side of each link, respectively;
a path condition setting means that sets an origin point node ID that identifies an origin point node that becomes an origin point for a path finding, and an origin point link ID that identifies an origin point link, and a destination point node ID that identifies a destination point node that becomes a destination point for the path finding;
a path finding means that
reads out the node ID of the node on the other side of the origin point link and one of the destination link IDs for the node on the other side by referring to an entry in the link destination table pointed to by the origin point link ID, and further by referring to an entry in the link destination table pointed to by the one of the destination link IDs, reads out a next node ID of a node on the other side of a next link whose link ID is the one of the destination link IDs and one of the next destination link IDs for the node on the other side, so as to perform repetition of reading out a node ID of a node on the other side of a next link and one of next destination link IDs for the node on the other side of the next link by further referring to an entry in the link destination table pointed to by the destination link ID for the node on the other side and accumulating the interval cost until the node ID on the other side coincides with the destination point node ID, and
expands all of the paths from the origin point node up to the destination point node by performing the repetition for all of the destination link IDs for a node on the other side stored in the link destination table and computes each cost of all of the paths expanded; and
an optimal path output means that selects the optimal path out of all of the paths expanded by the path finding means based on the each cost of all of the paths and outputs the optimal path.

2. A network path finding apparatus according to claim 1, wherein
the link destination table contains a connection cost corresponding to each of the destination link IDs for the node on one side and for the node on the other side, that is the cost of connecting from each link in a network to the link with a destination link ID of the node on one side or to the link with a destination link ID of the node on the other side, and
the path finding means, in the computation of path cost, accumulates that path connection cost in addition to the interval cost.

3. A network path finding apparatus according to claim 2, wherein
the path finding means accumulates the number of connections, which is the number of links connected to the origin point link in the path expansion, and an optimal path output means, if a plurality of paths with the same cost are expanded as optimal paths, selects an optimal path out of the plurality of expanded paths based on the number of connections.

4. A network path finding apparatus according to claim 2, wherein
the path finding means reads out, in addition to reading out the node ID of the node on the other side and one of the destination link IDs for the node on the other side and reading out, by referring to an entry of the link destination table pointed to by the one of the destination link IDs, a next node ID of a node on the other side of a next link whose link ID is the one of the destination link IDs and one of the next destination link IDs for the node on the other side, a node ID of a node on one side of the next link, and
when the node ID of the node on one side does not coincide with the next node ID, path expansion is not performed using the destination link ID for the further read-out node on the other side.

5. A network path finding apparatus according to claim 4, wherein
when the destination link ID of a node on the other side does not exist in the link destination table entry referred by a destination link ID, path expansion is not performed using the destination link ID.

6. A network path finding apparatus according to claim 2, wherein
the network is one such that a road network is modeled.

7. A car navigation apparatus that is equipped with a network path finding apparatus according to claim 6.

8. A vehicle equipped with a car navigation apparatus according to claim 7.

9. A network path finding method performed by the network path finding apparatus according to claim 1, comprising:
a path condition setting step that sets an origin point node ID that identifies an origin point node that becomes an origin point for a path finding, and an origin point link ID that identifies the origin point links, and a destination point node ID that identifies a destination point node that becomes a destination point for the path finding;
a path finding step that
reads out the node ID of the node on the other side of the origin point link and one of the destination link IDs for the node on the other side by referring to an entry in the link destination table pointed to by the origin point link ID, and further by referring to an entry in the link destination table pointed to by the one of the destination link IDs, reads out a next node ID of a node on the other side of a next link whose link ID is the one of the destination link IDs and one of the next destination link IDs for the node on the other side, so as to perform repetition of reading out a node ID of a node on the other side of a next link and one of next destination link IDs for the node on the other side of the next link by further referring to an entry in the link destination table pointed to by the destination link ID for the node on the other side and accumulating the interval cost until the node ID on the other side coincides with the destination point node ID, and
expands all of the paths from the origin point node up to the destination point node by performing the repetition for all of the destination link IDs for a node on the other side stored in the link destination table and computes each cost of all of the paths expanded; and
an optimal path output step that selects the optimal path out of all of the paths expanded by the path finding means based on the each cost of all of the paths and outputs the optimal path.

10. A network path finding method according to claim 9, wherein
the link destination table contains a connection cost corresponding to each of the destination link IDs for the node on one side and for the node on the other side, that is a cost of connecting from each link in a network to the link with a destination link ID of the node on one side or to the link with a destination link ID of the node on the other side,
and a path finding step that, in the computation of path cost, accumulates that path connection cost in addition to the interval cost.

11. A network path finding program for causing a computer to execute a network path finding method according to claim 9.

12. A network path finding program for causing a computer to execute a network path finding method according to claim 10.

13. A computer readable medium for storing the network path finding program according to claim 11.

14. A data configuration for representing a network consisting of nodes and links that connect between the nodes, comprising:
a link destination table that contains, for link IDs identifying each link in a network,
a node ID of a node on one side that identifies the node on one side of each of the links, and
destination link IDs for the node on one side that are link IDs identifying all of other links connected to the node on one side, and
a node ID of a node on the other side that identifies the node on the other side of each of the links, and
destination link IDs for the node on the other side that are link IDs identifying all of other links connected to the node on the other side, and
interval costs that are a cost from the node on one side to the node on the other side of each link and a cost from the node on the other side to the node on one side of each link, respectively; and wherein,
a path finding method according to claim 9 is enabled by using the link destination table.

15. A data configuration for representing a network consisting of nodes and links that connect between the nodes according to claim 14, wherein
the link destination table further contains a connection cost corresponding to each of the destination link IDs for the node on one side and for the node on the other side, that is the cost of connecting from each link in a network to the link with a destination link ID of the node on one side or to the link with a destination link ID of the node on the other side, and
that enables, in the computation of path cost, to accumulate that path connection cost in addition to the interval cost.

16. A link destination table generating apparatus wherein the link destination table represents a network consisting of nodes and links that connect between the nodes, comprising:
a link table containing, for link IDs that identify each link in a network, a node ID of a node on one side that identifies a node on one side for each link and a node ID of a node on the other side that identifies the node on the other side of each link;
an intersection table containing, for the node IDs that identify each node in a network, link IDs identifying all the links connected to each node;
a data configuration reading means that reads out data from the link table and the intersection table; and
a link destination table generating means that, for each link ID stored in the link table that is read out by the data configuration reading means,
by storing the node ID of the node on one side and the node ID of the node on the other side and also storing, as a destination link ID of the node on one side, from among link IDs of the links connected to the node on one side of which node ID is read out from the intersection table, all the link IDs except its own, and
furthermore, storing, as a destination link ID of the node on the other side, from among the link IDs of the links connected to the node on the other side of which node ID is read out from the intersection table, all the link IDs except its own,
generates a link destination table consisting of entries for the link ID, the node ID of a node on one side, destination link IDs for the node on one side, node ID of the node on the other side, and the destination link IDs of the node on the other side.

17. A link destination table generating method performed by the link destination table generating apparatus according to claim 16, comprising:
a data configuration reading step that reads out data from the link table and the intersection table; and
a link destination table generating step that, for each link ID stored in the link table that is read out at the data configuration reading step,
by storing the node ID of the node on one side and the node ID of the node on the other side and also storing, as a destination link ID of the node on one side, from among link IDs of the links connected to the node on one side of which node ID is read out from the intersection table, all the link IDs except its own, and
furthermore, storing, as a destination link ID of the node on the other side, from among the link IDs of the links connected to the node on the other side of which node ID is read out from the intersection table, all the link IDs except its own,
generates a link destination table consisting of entries for the link ID, the node ID of a node on one side, destination link IDs for the node on one side, node ID of the node on the other side, and the destination link IDs of the node on the other side.

18. A link destination table generating program for causing a computer to execute the link destination table generating method according to claim 17.

19. A computer readable medium for storing the link destination table generation program according to claim 18.
